(19) United States
(12) Patent Application Publication
(10) Pub. No.: US 2023/0026669 A1
(43) Pub. Date: Jan. 26, 2023

(54) IMAGE SENSOR WITH VARIABLE EXPOSURE TIME AND GAIN FACTOR

(71) Applicant: GoPro, Inc., San Mateo, CA (US)

(72) Inventor: Bruno César Douady, Orsay (FR)

(21) Appl. No.: 17/784,169

(22) PCT Filed: Jan. 17, 2020
(86) PCT No.: PCT/US2020/014063

§ 371 Date: Jun. 10, 2022

Related U.S. Application Data
(60) Provisional application No. 62/946,148, filed on Dec. 10, 2019.

(51) Int. Cl. H04N 5/235

(52) U.S. Cl. CPC H04N 5/2352

(57) ABSTRACT

An image capture system includes an image sensor which has pixel lines, a reset circuit, a readout circuit, and a processor. The processor configured to determine a first exposure time for a first portion of the image information, determine a second exposure time for a second portion of the image information, and variably control a pixel line exposure time for a selected line of pixels by signaling the reset circuit and the readout circuit at different times which are based on the first exposure time and the second exposure time, and where the first exposure time, the second exposure time, and the pixel line exposure time are elapsed times between the reset time and the read time. The image sensor further includes a gain element which is pixel line variably controlled using a first gain factor for the first portion and a second gain factor for the second portion.

### TECHNICAL FIELD

This disclosure relates to systems and techniques for exposure time and gain processing.

### BACKGROUND

Image capture devices, such as cameras, may capture content as images or video. Light may be received and focused via a lens and may be converted to an electronic image signal by an image sensor. The image signal may be processed by an image signal processor (ISP) to form an image, which may then be stored or output. In some cases, the image sensor may use a rolling shutter, where pixel lines at the top of the image sensor are exposed before the pixel lines at the bottom of the image sensor. The image sensor has logic which resets a pixel line at the same rate as the pixel line is readout to maintain a constant exposure time. Moreover, the gain applied to the pixel lines is maintained at a constant value. Using a constant exposure time and a constant gain value may not result in quality images.

### SUMMARY

Disclosed herein are implementations of systems and techniques for variable exposure time and gain processing.

A first aspect discloses an image capture device. The image capture device includes an image sensor configured to capture image information. The image sensor including an array of pixels, a reset circuit configured to reset a line of pixels in the array of pixels, and a readout circuit configured to obtain readout signals from the line of pixels, and a processor. The processor configured to determine a first exposure time for a first portion of the image information, determine a second exposure time for a second portion of the image information, and variably control a pixel line exposure time for a selected line of pixels by signaling the reset circuit at a reset time and the readout circuit at a readout time, where the reset time and the readout time are signaled at different times and are based on the first exposure time and the second exposure time, and wherein the first exposure time, the second exposure time, and the pixel line exposure time are elapsed times between the reset time and the read time. In some implementations, the image capture device includes the image sensor further including a gain element configured to amplify the readout signals. The processor is further configured to determine a first gain factor for a first portion of the image information, determine a second gain factor for a second portion of the image information, and variably control the gain element for the selected pixel line based on the first gain factor and the second gain factor. In some implementations, the processor is further configured to apply the first gain factor to a first line of pixels, apply the second gain factor to a last line of pixels, and determine gain factors for lines of pixels between the first line of pixels and the last line of pixels based on combinations of the first gain factor and the second gain factor. In some implementations, the processor is further configured to interpolate gain factors for lines of pixels between the first line of pixels and the last line of pixels based on the first gain factor and the second gain factor. In some implementations, the interpolation is linear between the first line of pixels and the last line of pixels. In some implementations, the processor is further configured to apply the first exposure time to a first line of pixels and apply the second exposure time to a last line of pixels. In some implementations, the processor is further configured to determine pixel line exposure times for lines of pixels between the first line of pixels and the last line of pixels based on combinations of the first exposure time and the second exposure time. In some implementations, the processor is further configured to interpolate pixel line exposure times for lines of pixels between the first line of pixels and the last line of pixels based on the first exposure time and the second exposure time. In some implementations, the interpolation is a linear function between the first line of pixels and the last line of pixels. The first aspect may include any combination of the features described in this paragraph and in the paragraphs of the second aspect, the third aspect, and the fourth aspect.

A second aspect discloses an image capture device. The image capture device includes an image sensor configured to capture image information, the image sensor including a plurality of pixel lines addressed by reset lines and readout lines and a processor. The processor is configured to determine a portion exposure time for a portion of the image information, where the image information includes two or more portions, and variably control a pixel line exposure time for a selected pixel line by signaling the reset line and the readout line at different times which are based on two or more portion exposure times, and wherein the portion exposure time, the two or more portion exposure times, and the pixel line exposure time are elapsed times between a reset time and a readout time. In some implementations, the image sensor further includes a gain element configured to amplify readout signals from the selected pixel line, where the processor is further configured to determine gain factors for the two or more portions and variably control the gain element for the selected pixel line based on the gain factors. In some implementations, the processor is further configured to determine a gain factor for the selected pixel line based on combinations of the gain factors for the two or more portions. In some implementations, the processor is further configured to determine the pixel line exposure time for the selected pixel line based on combinations of the two or more portion exposures. In some implementations, the two or more portions are a top portion of the image information and a bottom portion of the image information. In some implementations, the two or more portions are multiple groups of pixel lines. In some implementations, the two or more portions are all pixel lines in the image sensor. The second aspect may include any combination of the features described in this paragraph and in the paragraphs of the first aspect, the third aspect, and the fourth aspect.

A third aspect discloses a method for variable exposure time and gain processing. In some implementations, the method includes determining a portion exposure time for a portion of image information, wherein the image information includes two or more portions and variably controlling a pixel line exposure time for a selected pixel line of an image sensor by signaling a reset circuit at a reset time and a readout circuit at a readout time, where the reset time and the readout time are signaled at different times and are based on two or more portion exposure times, and where the portion exposure time, the two or more portion exposure times, and the pixel line exposure time are elapsed times between the reset time and the readout time. In some implementations, the method includes determining gain factors for the two or more portions and variably controlling the gain element for the selected pixel line based on the gain factors. In some implementations, the variably controlling the gain element further includes determining a gain factor for the selected pixel line based on combinations of the gain factors. In some implementations, the variably controlling further includes determining the pixel line exposure time for the selected pixel line based on combinations of the two or more exposures. The third aspect may include any combination of the features described in this paragraph and in the paragraphs of the first aspect, the second aspect, and the fourth aspect.

A fourth aspect discloses an image capture device. The image capture device includes an image sensor configured to capture image information, the image sensor including a plurality of pixel lines, a gain element configured to amplify readout signals from a selected pixel line, and a processor. The processor is configured to determine a gain factor for a portion of the image information, where the image information includes two or more portions and variably control the gain element for a selected pixel line based on the gain factors. In some implementations, the processor is further configured to determine a gain factor for the selected pixel line based on combinations of the gain factors for the two or more portions. In some implementations, the plurality of pixel lines is addressed by reset lines and readout lines, and the processor is further configured to determine portion exposure times for the two or more portions of the image information and variably control a pixel line exposure time for the selected pixel line by signaling the reset line and the readout line at different times which are based on the portion exposure times, where the portion exposure times and the pixel line exposure time are elapsed times between a reset time and a readout time. In some implementations, the processor is further configured to determine the pixel line exposure time for the selected pixel line based on combinations of the two or more portion exposures. In some implementations, the two or more portions are a top portion of the image information and a bottom portion of the image information. In some implementations, the two or more portions are multiple groups of pixel lines. In some implementations, the two or more portions are all pixel lines in the image sensor. The fourth aspect may include any combination of the features described in this paragraph and in the paragraphs of the first aspect, the second aspect, and the third aspect.

These and other aspects of this disclosure are disclosed in the following detailed description, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A-D are isometric views of an example of an image capture device.

FIGS. 2A-B are isometric views of another example of an image capture device.

FIG. 2C is a cross-sectional view of the image capture device of FIGS. 2A-B.

FIGS. 3A-B are block diagrams of examples of image capture systems.

FIGS. 4A-B are a perspective view and a schematic representation of an image capture device.

FIG. 5 is an illustration of reading and resetting pixel lines in an image sensor where a reading rate and a reset rate are set at the same rate.

FIG. 6 is a block diagram of an example of an image capture and processing pipeline with variable control of an exposure time and gain element.

FIG. 7 is an illustration of reading and resetting pixel lines of an image sensor where a reading time and a reset time are set at different rates.

FIG. 8 is a flowchart of an example of a process for variably controlling an exposure time and gain element based on a first portion of image information and a second portion of the image information.

FIG. 9 is a flowchart of an example of a process for variably controlling an exposure time and gain element based on groups of pixel lines in image information.

FIG. 10 is a flowchart of an example of a process for variably controlling an exposure time and gain element based on each pixel line in image information.

FIG. 11 is a flowchart of an example of a process for variably controlling an exposure time and gain element based on image information.

FIG. 12 is a flowchart of an example of a process for variably controlling a gain element and gain element based on image information.

### DETAILED DESCRIPTION

Image capture devices are designed with numerous features to assists users in producing high quality images. Images may be processed using one or more techniques to identify and/or enhance the content thereof. One example of such a feature is auto-exposure processing as performed by an auto-exposure module, where the auto-exposure module analyzes the images previously taken to determine the parameters to apply to the next image. In the case of high dynamic range (HDR) processing, several images can be captured with different parameters to be fused later on by an HDR module. The exposure time and gain used by an image sensor to capture an image is automatically adjusted based on lighting and related conditions of a scene in the direction of the image sensor.

Proper setting of the exposure time and gain is important to obtaining a quality image. For example, too short of an exposure time implies a lot of noise, too long of an exposure time implies motion blur and saturated pixels, too small of a gain implies read noise and quantization, and too large of a gain implies saturated pixels. The exposure time can be set by adjusting the aperture, the shutter speed, and/or other aspects of the image sensor or of the image capture device which are used by the image sensor to capture an image.

However, conventional approaches may suffer from drawbacks. In particular, the auto-exposure processing for the image sensors may result in poor image quality for the image ultimately produced using those image sensors. For example, a top part of a scene may be very bright while a bottom part of the scene may be very dark. In such a case, the auto-exposure processing determines a compromise exposure time and gain based on the top part of the scene and the bottom part of the scene. This may lead to the top part having too much exposure time and/or too much gain, and the bottom part having too little exposure time and/or too little gain, which in turn may lead to poor image quality.

Implementations of this disclosure address problems such as these by independently controlling reset and readout functionality of the image sensor to variably control an exposure time based on pixel line readout position. In some implementations, conventional gain processing may be applied to the readout signal. In some implementations, the gain may also be variably controlled based on the pixel line readout position. In an implementation, the auto-exposure module may determine a first set of exposure time and gain values for a top part of an image and determine a second set of exposure time and gain values for a bottom part of the image. The auto-exposure module may then variably control the exposure time for a pixel line number by signaling the reset and readout functionality based on a function of the exposure times from the first set and the second set. The gain may be similarly controlled on a pixel line number basis using the gain values times from the first set and the second set.

The implementations of this disclosure are described in detail with reference to the drawings, which are provided as examples so as to enable those skilled in the art to practice the technology. The figures and examples are not meant to limit the scope of the present disclosure to a single implementation, and other implementations are possible by way of interchange of, or combination with, some or all of the described or illustrated elements. Wherever convenient, the same reference numbers will be used throughout the drawings to refer to same or like parts.

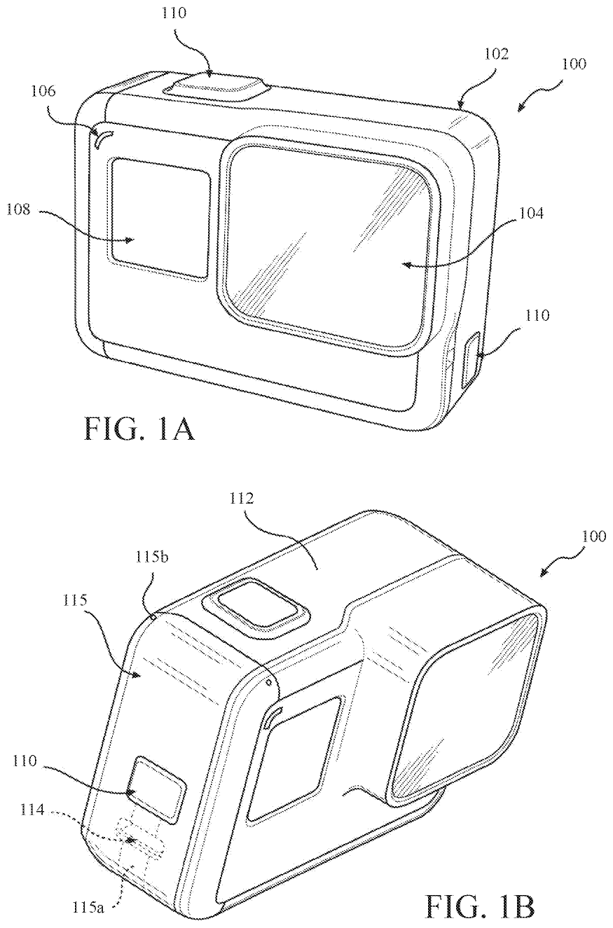

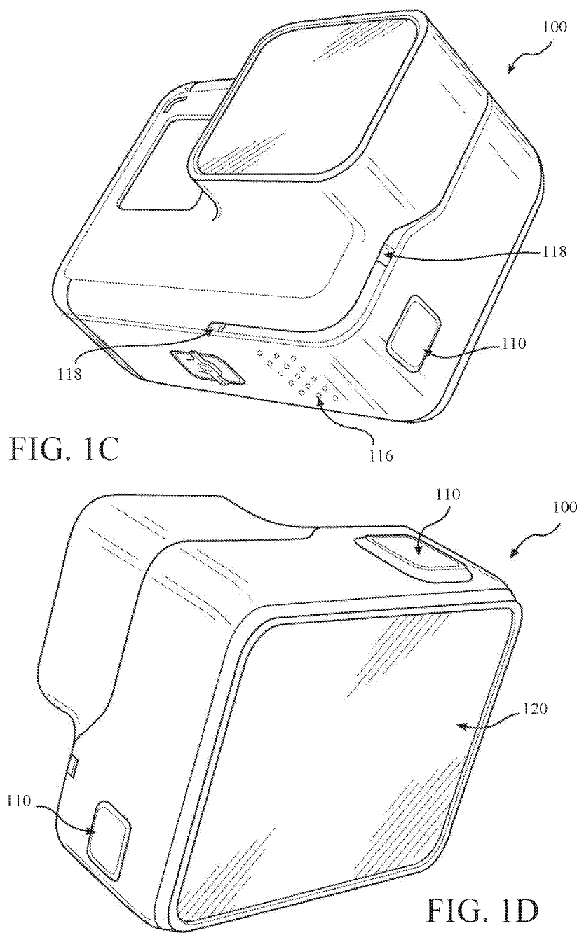

FIGS. 1A-D are isometric views of an example of an image capture device 100. The image capture device 100 may include a body 102 having a lens 104 structured on a front surface of the body 102, various indicators on the front of the surface of the body 102 (such as LEDs, displays, and the like), various input mechanisms (such as buttons, switches, and touch-screen mechanisms), and electronics (e.g., imaging electronics, power electronics, etc.) internal to the body 102 for capturing images via the lens 104 and/or performing other functions. The image capture device 100 may be configured to capture images and video and to store captured images and video for subsequent display or playback.

The image capture device 100 may include various indicators, including LED lights 106 and LCD display 108. The image capture device 100 may also include buttons 110 configured to allow a user of the image capture device 100 to interact with the image capture device 100, to turn the image capture device 100 on, to operate latches or hinges associated with doors of the image capture device 100, and/or to otherwise configure the operating mode of the image capture device 100. The image capture device 100 may also include a microphone 112 configured to receive and record audio signals in conjunction with recording video.

The image capture device 100 may include an I/O interface 114 (e.g., hidden as indicated using dotted lines). As best shown in FIG. 1B, the I/O interface 114 can be covered and sealed by a removable door 115 of the image capture device 100. The removable door 115 can be secured, for example, using a latch mechanism 115a (e.g., hidden as indicated using dotted lines) that is opened by engaging the associated button 110 as shown.

The removable door 115 can also be secured to the image capture device 100 using a hinge mechanism 115b, allowing the removable door 115 to pivot between an open position allowing access to the I/O interface 114 and a closed position blocking access to the I/O interface 114. The removable door 115 can also have a removed position (not shown) where the entire removable door 115 is separated from the image capture device 100, that is, where both the latch mechanism 115a and the hinge mechanism 115b allow the removable door 115 to be removed from the image capture device 100.

The image capture device 100 may also include another microphone 116 integrated into the body 102 or housing. The front surface of the image capture device 100 may include two drainage ports as part of a drainage channel 118. The image capture device 100 may include an interactive display 120 that allows for interaction with the image capture device 100 while simultaneously displaying information on a surface of the image capture device 100. As illustrated, the image capture device 100 may include the lens 104 that is configured to receive light incident upon the lens 104 and to direct received light onto an image sensor internal to the lens 104.

The image capture device 100 of FIGS. 1A-D includes an exterior that encompasses and protects internal electronics. In the present example, the exterior includes six surfaces (i.e. a front face, a left face, a right face, a back face, a top face, and a bottom face) that form a rectangular cuboid. Furthermore, both the front and rear surfaces of the image capture device 100 are rectangular. In other embodiments, the exterior may have a different shape. The image capture device 100 may be made of a rigid material such as plastic, aluminum, steel, or fiberglass. The image capture device 100 may include features other than those described here. For example, the image capture device 100 may include additional buttons or different interface features, such as interchangeable lenses, cold shoes and hot shoes that can add functional features to the image capture device 100, etc.

The image capture device 100 may include various types of image sensors, such as a charge-coupled device (CCD) sensors, active pixel sensors (APS), complementary metal-oxide-semiconductor (CMOS) sensors, N-type metal-oxide-semiconductor (NMOS) sensors, and/or any other image sensor or combination of image sensors.

Although not illustrated, in various embodiments, the image capture device 100 may include other additional electrical components (e.g., an image processor, camera SoC (system-on-chip), etc.), which may be included on one or more circuit boards within the body 102 of the image capture device 100.

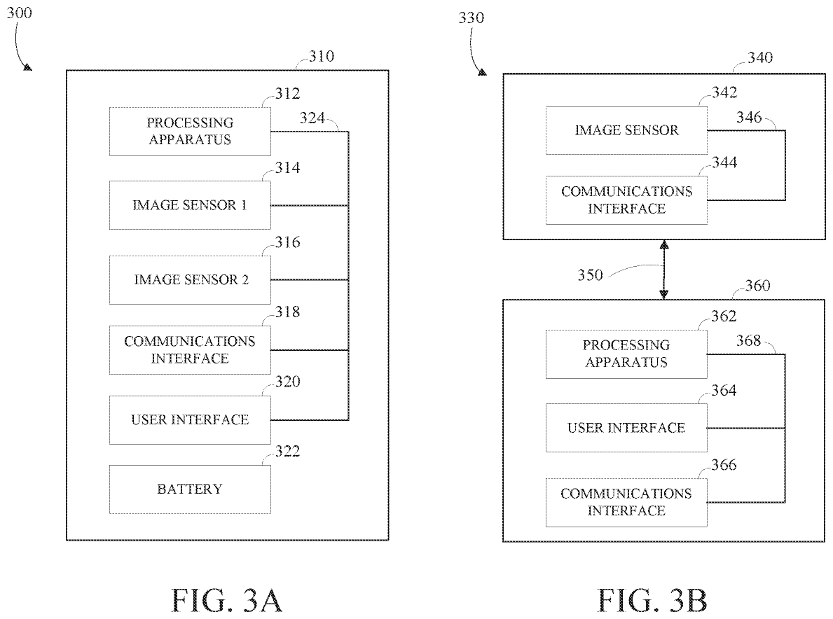

The image capture device 100 may interface with or communicate with an external device, such as an external user interface device, via a wired or wireless computing communication link (e.g., the I/O interface 114). The user interface device may, for example, be the personal computing device 360 described below with respect to FIG. 3B. Any number of computing communication links may be used. The computing communication link may be a direct computing communication link or an indirect computing communication link, such as a link including another device or a network, such as the internet, may be used.

In some implementations, the computing communication link may be a Wi-Fi link, an infrared link, a Bluetooth (BT) link, a cellular link, a ZigBee link, a near field communications (NFC) link, such as an ISO/IEC 20643 protocol link, an Advanced Network Technology interoperability (ANT+) link, and/or any other wireless communications link or combination of links.

In some implementations, the computing communication link may be an HDMI link, a USB link, a digital video interface link, a display port interface link, such as a Video Electronics Standards Association (VESA) digital display interface link, an Ethernet link, a Thunderbolt link, and/or other wired computing communication link.

The image capture device 100 may transmit images, such as panoramic images, or portions thereof, to the user interface device (not shown) via the computing communication link, and the user interface device may store, process, display, or a combination thereof the panoramic images.

The user interface device may be a computing device, such as a smartphone, a tablet computer, a phablet, a smart watch, a portable computer, and/or another device or combination of devices configured to receive user input, communicate information with the image capture device 100 via the computing communication link, or receive user input and communicate information with the image capture device 100 via the computing communication link.

The user interface device may display, or otherwise present, content, such as images or video, acquired by the image capture device 100. For example, a display of the user interface device may be a viewport into the three-dimensional space represented by the panoramic images or video captured or created by the image capture device 100.

The user interface device may communicate information, such as metadata, to the image capture device 100. For example, the user interface device may send orientation information of the user interface device with respect to a defined coordinate system to the image capture device 100, such that the image capture device 100 may determine an orientation of the user interface device relative to the image capture device 100.

Based on the determined orientation, the image capture device 100 may identify a portion of the panoramic images or video captured by the image capture device 100 for the image capture device 100 to send to the user interface device for presentation as the viewport. In some implementations, based on the determined orientation, the image capture device 100 may determine the location of the user interface device and/or the dimensions for viewing of a portion of the panoramic images or video.

The user interface device may implement or execute one or more applications to manage or control the image capture device 100. For example, the user interface device may include an application for controlling camera configuration, video acquisition, video display, or any other configurable or controllable aspect of the image capture device 100.

The user interface device, such as via an application, may generate and share, such as via a cloud-based or social media service, one or more images, or short video clips, such as in response to user input. In some implementations, the user interface device, such as via an application, may remotely control the image capture device 100 such as in response to user input.

The user interface device, such as via an application, may display unprocessed or minimally processed images or video captured by the image capture device 100 contemporaneously with capturing the images or video by the image capture device 100, such as for shot framing, which may be referred to herein as a live preview, and which may be performed in response to user input. In some implementations, the user interface device, such as via an application, may mark one or more key moments contemporaneously with capturing the images or video by the image capture device 100, such as with a tag, such as in response to user input.

The user interface device, such as via an application, may display, or otherwise present, marks or tags associated with images or video, such as in response to user input. For example, marks may be presented in a camera roll application for location review and/or playback of video highlights.

The user interface device, such as via an application, may wirelessly control camera software, hardware, or both. For example, the user interface device may include a web-based graphical interface accessible by a user for selecting a live or previously recorded video stream from the image capture device 100 for display on the user interface device.

The user interface device may receive information indicating a user setting, such as an image resolution setting (e.g., 3840 pixels by 2160 pixels), a frame rate setting (e.g., 60 frames per second (fps)), a location setting, and/or a context setting, which may indicate an activity, such as mountain biking, in response to user input, and may communicate the settings, or related information, to the image capture device 100.

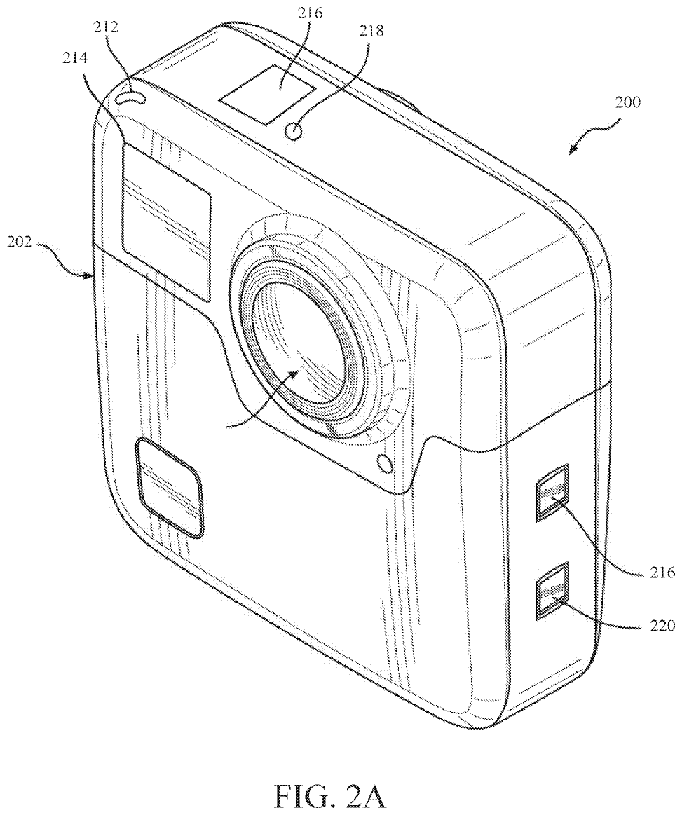

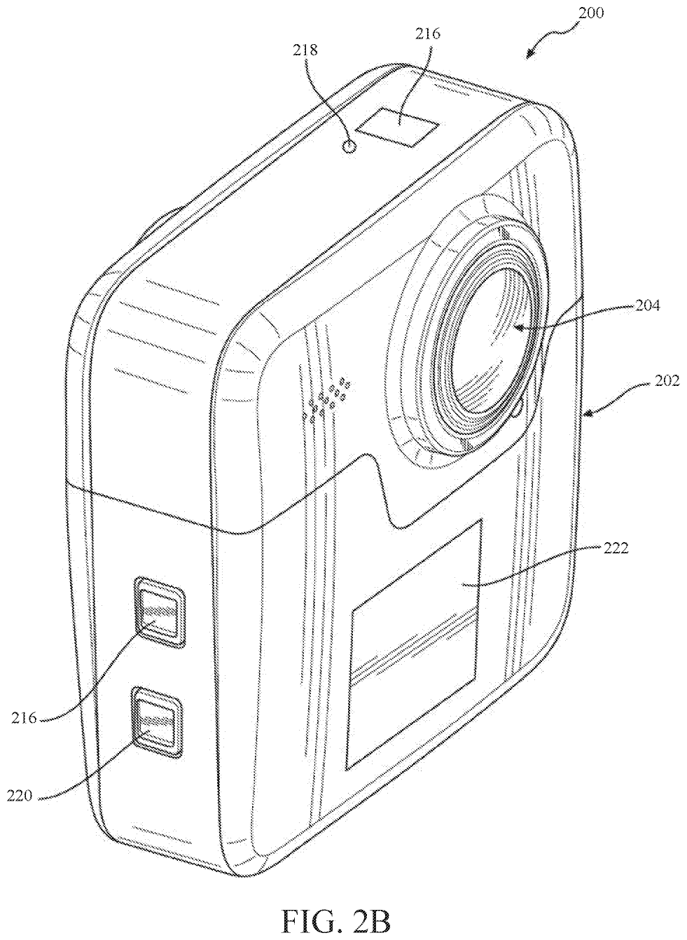

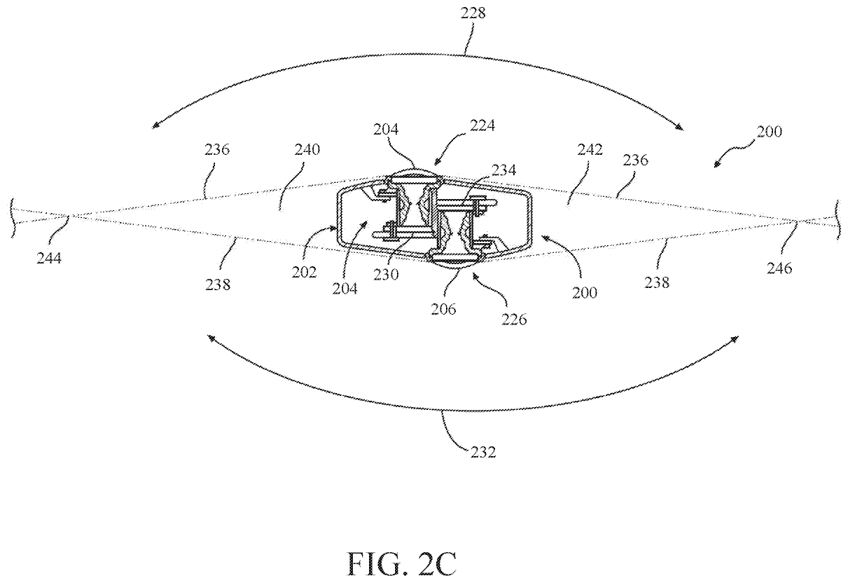

FIGS. 2A-B illustrate another example of an image capture device 200. The image capture device 200 includes a body 202 and two camera lenses 204, 206 disposed on opposing surfaces of the body 202, for example, in a back-to-back or Janus configuration.

The image capture device may include electronics (e.g., imaging electronics, power electronics, etc.) internal to the body 202 for capturing images via the lenses 204, 206 and/or performing other functions. The image capture device may include various indicators such as an LED light 212 and an LCD display 214.

The image capture device 200 may include various input mechanisms such as buttons, switches, and touchscreen mechanisms. For example, the image capture device 200 may include buttons 216 configured to allow a user of the image capture device 200 to interact with the image capture device 200, to turn the image capture device 200 on, and to otherwise configure the operating mode of the image capture device 200. In an implementation, the image capture device 200 includes a shutter button and a mode button. It should be appreciated, however, that, in alternate embodiments, the image capture device 200 may include additional buttons to support and/or control additional functionality.

The image capture device 200 may also include one or more microphones 218 configured to receive and record audio signals (e.g., voice or other audio commands) in conjunction with recording video.

The image capture device 200 may include an I/O interface 220 and an interactive display 222 that allows for interaction with the image capture device 200 while simultaneously displaying information on a surface of the image capture device 200.

The image capture device 200 may be made of a rigid material such as plastic, aluminum, steel, or fiberglass. In some embodiments, the image capture device 200 described herein includes features other than those described. For example, instead of the I/O interface 220 and the interactive display 222, the image capture device 200 may include additional interfaces or different interface features. For example, the image capture device 200 may include additional buttons or different interface features, such as interchangeable lenses, cold shoes and hot shoes that can add functional features to the image capture device 200, etc.

FIG. 2C is a cross-sectional view of the image capture device 200 of FIGS. 2A-B. The image capture device 200 is configured to capture spherical images, and accordingly, includes a first image capture device 224 and a second image capture device 226. The first image capture device 224 defines a first field-of-view 228 as shown in FIG. 2C and includes the lens 204 that receives and directs light onto a first image sensor 230.

Similarly, the second image capture device 226 defines a second field-of-view 232 as shown in FIG. 2C and includes the lens 206 that receives and directs light onto a second image sensor 234. To facilitate the capture of spherical images, the image capture devices 224, 226 (and related components) may be arranged in a back-to-back (Janus) configuration such that the lenses 204, 206 face in generally opposite directions.

The fields-of-view 228, 232 of the lenses 204, 206 are shown above and below boundaries 236, 238, respectively. Behind the first lens 204, the first image sensor 230 may capture a first hyper-hemispherical image plane from light entering the first lens 204, and behind the second lens 206, the second image sensor 234 may capture a second hyper-hemispherical image plane from light entering the second lens 206.

One or more areas, such as blind spots 240, 242 may be outside of the fields-of-view 228, 232 of the lenses 204, 206 so as to define a “dead zone.” In the dead zone, light may be obscured from the lenses 204, 206 and the corresponding image sensors 230, 234, and content in the blind spots 240, 242 may be omitted from capture. In some implementations, the image capture devices 224, 226 may be configured to minimize the blind spots 240, 242.

The fields-of-view 228, 232 may overlap. Stitch points 244, 246, proximal to the image capture device 200, at which the fields-of-view 228, 232 overlap may be referred to herein as overlap points or stitch points. Content captured by the respective lenses 204, 206, distal to the stitch points 244, 246, may overlap.

Images contemporaneously captured by the respective image sensors 230, 234 may be combined to form a combined image. Combining the respective images may include correlating the overlapping regions captured by the respective image sensors 230, 234, aligning the captured fields-of-view 228, 232, and stitching the images together to form a cohesive combined image.

A slight change in the alignment, such as position and/or tilt, of the lenses 204, 206, the image sensors 230, 234, or both, may change the relative positions of their respective fields-of-view 228, 232 and the locations of the stitch points 244, 246. A change in alignment may affect the size of the blind spots 240, 242, which may include changing the size of the blind spots 240, 242 unequally.

Incomplete or inaccurate information indicating the alignment of the image capture devices 224, 226, such as the locations of the stitch points 244, 246, may decrease the accuracy, efficiency, or both of generating a combined image. In some implementations, the image capture device 200 may maintain information indicating the location and orientation of the lenses 204, 206 and the image sensors 230, 234 such that the fields-of-view 228, 232, stitch points 244, 246, or both may be accurately determined, which may improve the accuracy, efficiency, or both of generating a combined image.

The lenses 204, 206 may be laterally offset from each other, may be off-center from a central axis of the image capture device 200, or may be laterally offset and off-center from the central axis. As compared to image capture devices with back-to-back lenses, such as lenses aligned along the same axis, image capture devices including laterally offset lenses may include substantially reduced thickness relative to the lengths of the lens barrels securing the lenses. For example, the overall thickness of the image capture device 200 may be close to the length of a single lens barrel as opposed to twice the length of a single lens barrel as in a back-to-back configuration. Reducing the lateral distance between the lenses 204, 206 may improve the overlap in the fields-of-view 228, 232.

Images or frames captured by the image capture devices 224, 226 may be combined, merged, or stitched together to produce a combined image, such as a spherical or panoramic image, which may be an equirectangular planar image. In some implementations, generating a combined image may include three-dimensional, or spatiotemporal, noise reduction (3DNR). In some implementations, pixels along the stitch boundary may be matched accurately to minimize boundary discontinuities.

FIGS. 3A-B are block diagrams of examples of image capture systems. Referring first to FIG. 3A, an image capture system 300 is shown. The image capture system 300 includes an image capture device 310 (e.g., a camera or a drone), which may, for example, be the image capture device 200 shown in FIGS. 2A-C.

The image capture device 310 includes a processing apparatus 312 that is configured to receive a first image from a first image sensor 314 and receive a second image from a second image sensor 316. The image capture device 310 includes a communications interface 318 for transferring images to other devices. The image capture device 310 includes a user interface 320 to allow a user to control image capture functions and/or view images. The image capture device 310 includes a battery 322 for powering the image capture device 310. The components of the image capture device 310 may communicate with each other via the bus 324.

The processing apparatus 312 may be configured to perform image signal processing (e.g., filtering, tone mapping, stitching, and/or encoding) to generate output images based on image data from the image sensors 314 and 316. The processing apparatus 312 may include one or more processors having single or multiple processing cores. The processing apparatus 312 may include memory, such as a random-access memory device (RAM), flash memory, or another suitable type of storage device such as a non-transitory computer-readable memory. The memory of the processing apparatus 312 may include executable instructions and data that can be accessed by one or more processors of the processing apparatus 312.

For example, the processing apparatus 312 may include one or more dynamic random access memory (DRAM) modules, such as double data rate synchronous dynamic random-access memory (DDR SDRAM). In some implementations, the processing apparatus 312 may include a digital signal processor (DSP). In some implementations, the processing apparatus 312 may include an application specific integrated circuit (ASIC). For example, the processing apparatus 312 may include a custom image signal processor.

The first image sensor 314 and the second image sensor 316 may be configured to detect light of a certain spectrum (e.g., the visible spectrum or the infrared spectrum) and convey information constituting an image as electrical signals (e.g., analog or digital signals). For example, the image sensors 314 and 316 may include CCDs or active pixel sensors in a CMOS. The image sensors 314 and 316 may detect light incident through a respective lens (e.g., a fisheye lens). In some implementations, the image sensors 314 and 316 include digital-to-analog converters. In some implementations, the image sensors 314 and 316 are held in a fixed orientation with respective fields of view that overlap.

The communications interface 318 may enable communications with a personal computing device (e.g., a smartphone, a tablet, a laptop computer, or a desktop computer). For example, the communications interface 318 may be used to receive commands controlling image capture and processing in the image capture device 310. For example, the communications interface 318 may be used to transfer image data to a personal computing device. For example, the communications interface 318 may include a wired interface, such as a high-definition multimedia interface (HDMI), a universal serial bus (USB) interface, or a FireWire interface. For example, the communications interface 318 may include a wireless interface, such as a Bluetooth interface, a ZigBee interface, and/or a Wi-Fi interface.

The user interface 320 may include an LCD display for presenting images and/or messages to a user. For example, the user interface 320 may include a button or switch enabling a person to manually turn the image capture device 310 on and off. For example, the user interface 320 may include a shutter button for snapping pictures.

The battery 322 may power the image capture device 310 and/or its peripherals. For example, the battery 322 may be charged wirelessly or through a micro-USB interface.

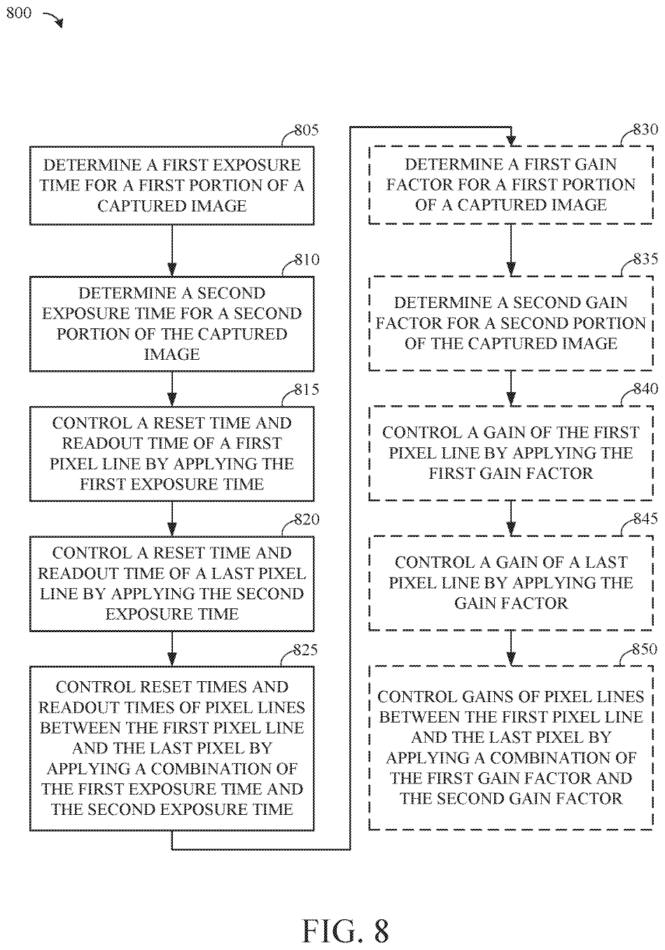

The image capture system 300 may be used to implement some or all of the techniques described in this disclosure, such as the technique 700, the technique 800, the technique 900, and/or the technique 1000, respectively described with respect to FIGS. 8-12.

Referring next to FIG. 3B, another image capture system 330 is shown. The image capture system 330 includes an image capture device 340 and a personal computing device 360 that communicate via a communications link 350. The image capture device 340 may, for example, be the image capture device 100 shown in FIGS. 1A-D. The personal computing device 360 may, for example, be the user interface device described with respect to FIGS. 1A-D.

The image capture device 340 includes an image sensor 342 that is configured to capture images. The image capture device 340 includes a communications interface 344 configured to transfer images via the communication link 350 to the personal computing device 360.

The personal computing device 360 includes a processing apparatus 362 that is configured to receive, using a communications interface 366, images from the image sensor 342. The processing apparatus 362 may be configured to perform image signal processing (e.g., filtering, tone mapping, stitching, and/or encoding) to generate output images based on image data from the image sensor 342.

The image sensor 342 is configured to detect light of a certain spectrum (e.g., the visible spectrum or the infrared spectrum) and convey information constituting an image as electrical signals (e.g., analog or digital signals). For example, the image sensor 342 may include CCDs or active pixel sensors in a CMOS. The image sensor 342 may detect light incident through a respective lens (e.g., a fisheye lens). In some implementations, the image sensor 342 includes digital-to-analog converters. Image signals from the image sensor 342 may be passed to other components of the image capture device 340 via a bus 346.

The communications link 350 may be a wired communications link or a wireless communications link. The communications interface 344 and the communications interface 366 may enable communications over the communications link 350. For example, the communications interface 344 and the communications interface 366 may include an HDMI port or other interface, a USB port or other interface, a FireWire interface, a Bluetooth interface, a ZigBee interface, and/or a Wi-Fi interface. For example, the communications interface 344 and the communications interface 366 may be used to transfer image data from the image capture device 340 to the personal computing device 360 for image signal processing (e.g., filtering, tone mapping, stitching, and/or encoding) to generate output images based on image data from the image sensor 342.

The processing apparatus 362 may include one or more processors having single or multiple processing cores. The processing apparatus 362 may include memory, such as RAM, flash memory, or another suitable type of storage device such as a non-transitory computer-readable memory. The memory of the processing apparatus 362 may include executable instructions and data that can be accessed by one or more processors of the processing apparatus 362. For example, the processing apparatus 362 may include one or more DRAM modules, such as DDR SDRAM.

In some implementations, the processing apparatus 362 may include a DSP. In some implementations, the processing apparatus 362 may include an integrated circuit, for example, an ASIC. For example, the processing apparatus 362 may include a custom image signal processor. The processing apparatus 362 may exchange data (e.g., image data) with other components of the personal computing device 360 via a bus 368.

The personal computing device 360 may include a user interface 364. For example, the user interface 364 may include a touchscreen display for presenting images and/or messages to a user and receiving commands from a user. For example, the user interface 364 may include a button or switch enabling a person to manually turn the personal computing device 360 on and off In some implementations, commands (e.g., start recording video, stop recording video, or capture photo) received via the user interface 364 may be passed on to the image capture device 340 via the communications link 350.

The image capture system 330 may be used to implement some or all of the techniques described in this disclosure, such as the technique 700, the technique 800, the technique 900, and/or the technique 1000, respectively described with respect to FIGS. 8-12.

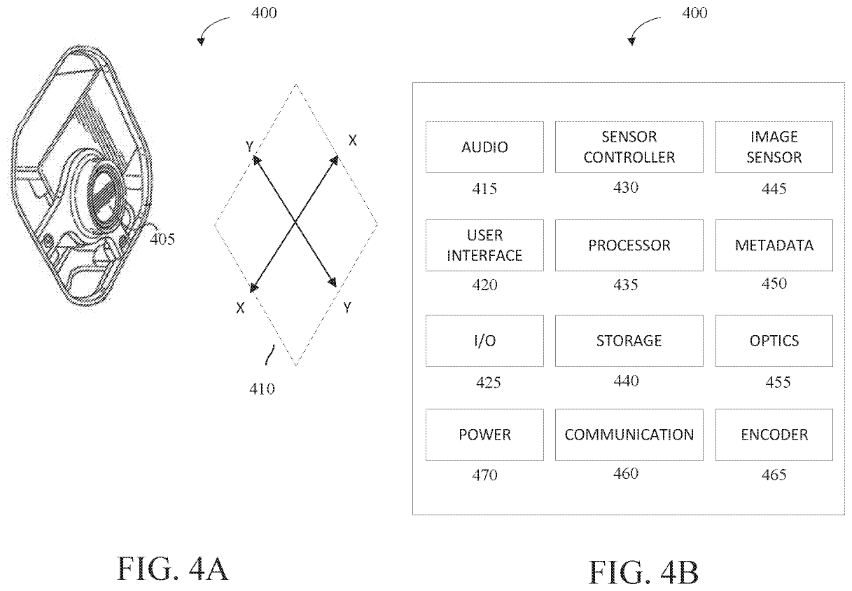

FIG. 4A is a perspective view of another example of an image capture device 400 together with an associated field-of-view and FIG. 4B is a schematic representation of the image capture device 400. The image capture device 400 includes one or more optical components or elements 405 with an associated field-of-view 410 that extends, for example, 90° in a lateral dimension X-X and 120° in a longitudinal dimension Y-Y. Dependent upon the capabilities of the particular optical component(s) 405, however, the extent of the field-of-view 410 may be varied (i.e., increased or decreased) in the lateral dimension or the longitudinal dimension. Suitable optical component(s) 405 may include one or more lenses, macro lenses, zoom lenses, special-purpose lenses, telephoto lenses, prime lenses, achromatic lenses, apochromatic lenses, process lenses, wide-angle lenses, ultra-wide-angle lenses, fisheye lenses, infrared lenses, ultraviolet lenses, spherical lenses, and perspective control lenses. In some image capture devices, multiple, overlapping fields of view are employed to increase the capability of the device, for example, by including two or more optical elements. For example, a first fisheye image may be a round or elliptical image, and may be transformed into a first rectangular image; a second fisheye image may be a round or elliptical image, and may be transformed into a second rectangular image; and the first and second rectangular images may be arranged side-by-side, which may include overlapping, and stitched together to form the equirectangular planar image.

As seen in FIG. 4A in addition to the optical component(s) 405, the image capture device 400 may further include an audio component 415, a user interface (UI) unit 420, an input/output (I/O) unit 425, a sensor controller 430, a processor 435, an electronic storage unit 440, an image sensor 445, a metadata unit 450, an optics unit 455, a communication unit 460, an encoder 465, and power system 470. Suitable examples of the image sensor 445 may include a charge-coupled device (CCD) sensor, an active pixel sensor (APS), a complementary metal-oxide semiconductor (CMOS) sensor, an N-type metal-oxide-semiconductor (NMOS) sensor, and/or any other image sensor or combination of image sensors.

During the processing of images, it is envisioned that the processor 435 may process the image data for variable exposure time and gain processing. The processor 435 may implement some or all of the techniques described in this disclosure, such as the techniques variable exposure time and gain processing as described in FIGS. 8-12.

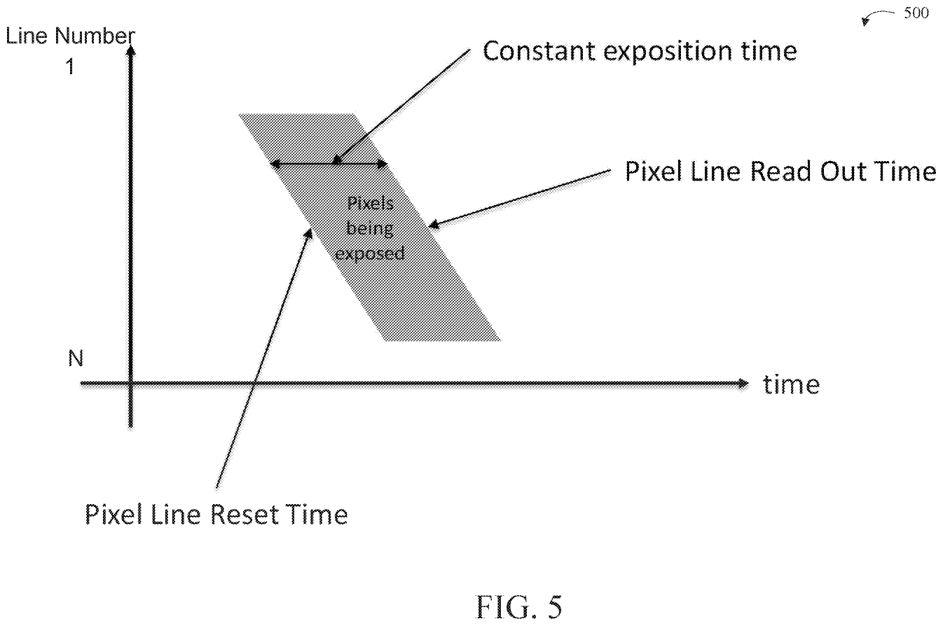

FIG. 5 is an illustration 500 of constant exposition time when reading and resetting pixel lines in an image sensor where a reading time and a reset time are set or signaled at the same rate. An image capture device includes an image sensor which has an array of pixels, where each row of pixels may be identified as a pixel line. The image sensor and/or the image capture device includes logic that reads and resets the pixel lines. When a pixel line is read, each pixel in the pixel line reports a value which is proportional to the quantity of light received at the pixel since the last time the pixel line was reset. An exposure time is the elapsed time between the reset time and the read time.

Image sensors may use a rolling shutter technique to read and reset pixel lines, where the pixel lines at the top of the image sensor are exposed before the pixel lines at the bottom of the image sensor such that pixels can be output at the time they are read. To maintain a constant exposure time, the image sensor has internal logic that resets pixel lines line after line at the same rate as the pixel lines are read. That is, the internal logic of the image sensor reset pixel lines one after the other and at the same rate reads pixel lines one after the other (i.e., both processes happen in parallel). Both the read logic and the reset logic operate at the same rate. For example, a pixel line may be reset every 3 μs, a pixel line may be read every 3 μs, and each pixel line is read 3ms after being reset. The exposure time is therefore constant as shown in FIG. 5, where the shaded area has a constant width or time period for all pixel lines from pixel line 1 to pixel line N. In addition, during this process, the gain applied at a readout amplifier is maintained at a constant value (standard or conventional gain processing).

Proper setting of the exposure time and gain is important to obtaining a quality image since a top part of a scene may be very bright while a bottom part of the scene may be very dark, for example. A compromise exposure time and gain based on the top part of the scene and the bottom part of the scene may be used for reading and resetting each pixel line. This may lead to the top part having too much exposure time and/or too much gain, and the bottom part having too little exposure time and/or too little gain, which in turn may lead to poor image quality.

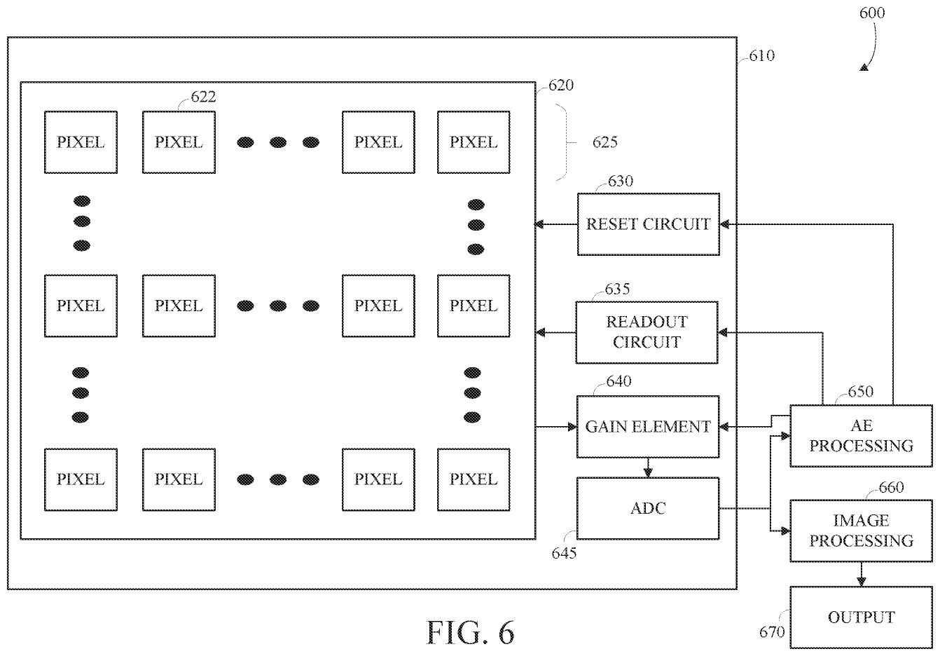

FIG. 6 is a block diagram of an example of an image capture and processing pipeline 600 with variable control of an exposure time and/or gain element. The image capture and processing pipeline 600 is implemented by an image capture device, which may, for example, be the image capture device 100 shown in FIGS. 1A-D, the image capture device 200 shown in FIGS. 2A-C, or another image capture device. In some implementations, some or all of the pipeline 600 may represent functionality of a DSP and/or an ASIC, for example, including an image capture unit, an image processing unit, a processor, or a combined image capture and processing unit.

The pipeline 600 includes an image sensor 610 that captures an image, an auto-exposure processing unit 650 which determines and controls exposure times and gain factors, and an image processing unit 660 that processes the image to produce output 670. The image sensor may be an image sensor of an image capture device. For example, the image sensor 610 may be one or more of an image sensor of the image capture device 100, an image sensor of the image capture device 200 (e.g., the image sensor 240 or the image sensor 242), an image sensor of the image capture device 300 (e.g., the first image sensor 314 or the second image sensor 316), or an image sensor of the image capture device 340 (e.g., the first image sensor 342 or the second image sensor 344). In an implementation, the auto-exposure processing unit 650 and the image processing unit 660 may be an integrated unit. In an implementation, the auto-exposure processing unit 650 and the image processing unit 660 may be implemented using a processor such as processor 435.

The image sensor 610 includes an array of pixels 620 which captures and produces a value responsive to the quantity of received light, where a row of pixels is a pixel line 625. The image sensor 610 further includes a readout circuit 630 which causes pixels 622 in a signaled pixel line 625 to report the value and a reset circuit 635 which resets a signaled pixel line 625. That is, each pixel is addressed by a read line and reset line. The image sensor 610 further includes a gain element 640 which applies a gain to the pixel line 625 that is being readout and an analog-to-digital converter (ADC) 645 which converts the pixel line 625 to a digital representation for processing by the auto-exposure processing unit 650 and the image processing unit 660. In an implementation, the gain element 640 is an amplifier. In an implementation, the gain element 640 is an operational amplifier.

The capturing of the image using the image sensor 610 may be responsive to a user of an image capture device implementing the pipeline 600 indicating to capture an image, for example, by the user interacting with an interface element of the image capture device which causes images to be captured by the image sensor 610. Alternatively, the capturing of the image using the image sensor 610 may be automated based on one or more configurations of the image sensor 610.

The auto-exposure processing unit 650 obtains, such by generating or determining, exposure times, gain factors, or both based on the capturing of the image by the image sensor 610. The auto-exposure processing unit 650 applies a conventional or standard technique or algorithm to multiple portions of the image and obtains an exposure time, gain factor, or both for each portion of the image under consideration. For example, the conventional or standard technique or algorithm may be based on target exposure, where exposure time and gain are adjusted so that the average image value is x % of the full scale. For example, x % may be 12.5%.

In some implementations, the auto-exposure processing unit 650 may then use the multiple exposure times to program the image sensor 610. For example, the image sensor 610 may apply a first exposure time from the multiple exposure times to a first pixel line, apply a second exposure time from the multiple exposure times to a last pixel line, and apply interpolated exposure times for the pixel lines between the first pixel line and the last pixel line. In an implementation, the auto-exposure processing unit 650 may control the signaling of the readout circuit 630 and the reset circuit 635 on a per pixel line basis. In an implementation, the auto-exposure processing unit 650 can control the signaling of the readout circuit 630 and the reset circuit 635 at different rates. In an implementation, the auto-exposure processing unit 650 may control the signaling of the readout circuit 630 and the reset circuit 635 using the techniques described with respect to FIGS. 8-12.

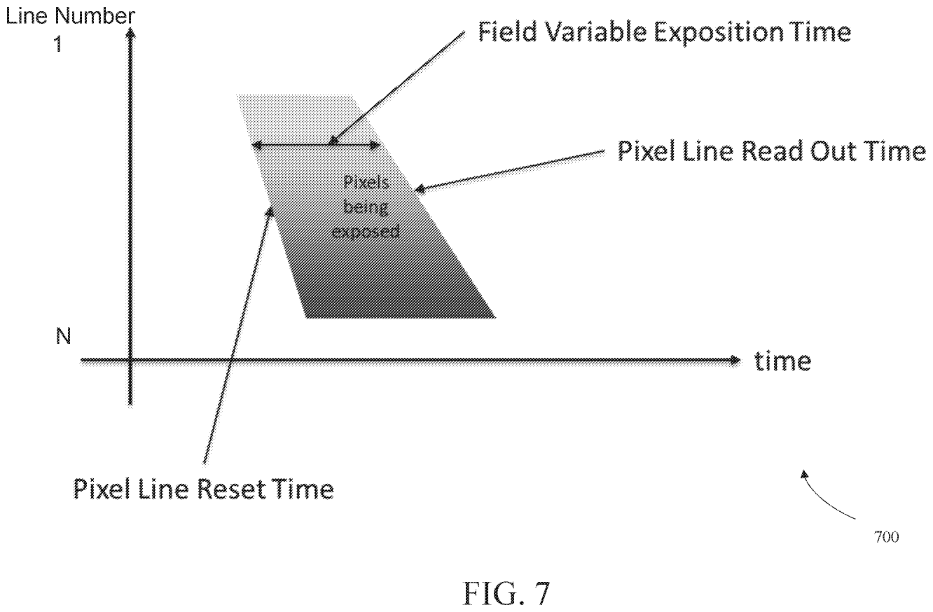

FIG. 7 is an illustration 700 of reading and resetting pixel lines of an image sensor where a reading time and a reset time are set at different rates. As shown, the exposure time is variable, where the shaded area has a widening width or time period as the pixel lines are processed starting from pixel line 1 to pixel line N. This can be referred to as field variable exposition time, where the exposure time is field variable based on the y-coordinate or y position. For example, assume that an image sensor has 3000 pixel lines. Using the variable exposure time and gain processing described herein, a pixel line is reset every 2 μs and a pixel line is read every 3 μs. In this instance, the first pixel line is read 3 ms after being reset and the last pixel line is read 6 ms after being reset (3000×(3 μs−2 μs)=3 ms). The exposure time depends on the y coordinate of the pixel but not on the x coordinate.

In some implementations, the gain element 640 may apply conventional gain processing to each pixel line 625 that is readout from the array of pixels 620. In some implementations, the auto-exposure processing unit 650 may control the amount of gain that is applied by the gain element 640 to the pixel line 625 that is being readout. In an implementation, the auto-exposure processing unit 650 may control the gain element 640 on a per pixel line basis. In an implementation, the auto-exposure processing unit 650 may apply a first gain factor from the multiple gain factors to a first pixel line, apply a second gain factor from the multiple gain factors to a last pixel line, and apply interpolated gain factors for the pixel lines between the first pixel line and the last pixel line. In an implementation, the applied gain may be linearly dependent on the pixel line number, on the y-coordinate, or y position. In an implementation, the image processing unit 660 can apply a variable inverse gain to ensure that the exposition and/or gain is homogenous throughout the image at the output 670.

In some implementations, conventional or standard exposure time processing may be used for the pixel lines 625. In these implementations, the auto-exposure processing unit 650 may control the amount of gain that is applied by the gain element 640 to the pixel line 625 that is being readout. In an implementation, the auto-exposure processing unit 650 may control the gain element 640 on a per pixel line basis. In an implementation, the auto-exposure processing unit 650 may apply a first gain factor from the multiple gain factors to a first pixel line, apply a second gain factor from the multiple gain factors to a last pixel line, and apply interpolated gain factors for the pixel lines between the first pixel line and the last pixel line. In an implementation, the applied gain may be linearly dependent on the pixel line number, on the y-coordinate, or y position. In an implementation, the image processing unit 660 can apply a variable inverse gain to ensure that the exposition and/or gain is homogenous throughout the image at the output 670.

FIG. 8 is a flowchart of an example technique 800 for performing variable exposure time processing and gain processing. The technique 800 includes: determining 805 a first exposure time for a first portion of a captured image; determining 810 a second exposure time for a second portion of the captured image; controlling 815 a reset time and readout time of a first pixel line by applying the first exposure time; controlling 820 a reset time and readout time of a last pixel line by applying the second exposure time; and controlling 825 reset times and readout times of pixel lines between the first pixel line and the last pixel by applying a combination of the first exposure time and the second exposure time. In an implementation, the technique 800 further includes determining 830 a first gain factor for a first portion of a captured image; determining 835 a second gain factor for a second portion of the captured image; controlling 840 a gain of the first pixel line by applying the first gain factor; controlling 845 a gain of a last pixel line by applying the gain factor; and controlling 850 gains of pixel lines between the first pixel line and the last pixel by applying a combination of the first gain factor and the second gain factor. For example, the technique 800 may be implemented by the image capture device 100 shown in FIGS. 1A-1D, the image capture device 200 shown in FIGS. 2A-2D, the image capture device 310 shown in FIGS. 3A-3B, or the image capture device 400 of FIGS. 4A-4B. The order is illustrative and may occur in other orders or in combined steps.

The technique 800 includes determining 805 a first exposure time for a first portion of a captured image and determining 810 a second exposure time for a second portion of the captured image. An image is captured by an image sensor of an image capture device. An auto-exposure module or processor of the image capture device divides the captured image based on an image characteristic or feature. For example, the first portion of the captured image may be a bright portion of the captured image. For example, the first portion of the captured image may be a sky portion of the captured image. For example, the first portion of the captured image may be a top half portion of the captured image. For example, the second portion of the captured image may be a dark portion of the captured image. For example, the first portion of the captured image may be a ground portion of the captured image. For example, the first portion of the captured image may be a bottom half portion of the captured image. The auto-exposure module or processor of the image capture device then determines an exposure time for each portion using conventional or standard techniques.

The technique 800 includes controlling 815 a reset time and readout time of a first pixel line by applying the first exposure time, controlling 820 a reset time and readout time of a last pixel line by applying the second exposure time, and controlling 825 reset times and readout times of pixel lines between the first pixel line and the last pixel by applying a combination of the first exposure time and the second exposure time. The auto-exposure module or processor programs or controls the reset and read times of the image sensor using the first exposure time and the second exposure time. By setting different times for the reset and read times, the exposure time can be varied on a per pixel line basis. In an implementation, conventional or standard gain processing may be applied to each pixel line that is readout.

In some implementations, the technique 800 includes determining 830 a first gain factor for a first portion of a captured image and determining 835 a second gain factor for a second portion of the captured image. The auto-exposure module or processor determines gain factors for each portion using conventional or standard techniques.

The technique 800 includes controlling 840 a gain of the first pixel line by applying the first gain factor, controlling 845 a gain of a last pixel line by applying the gain factor, and controlling 850 gains of pixel lines between the first pixel line and the last pixel by applying a combination of the first gain factor and the second gain factor. The auto-exposure module or processor programs or controls the gain element of the image sensor using the first gain factor and the second gain factor. The gain factor can be varied on a per pixel line basis.

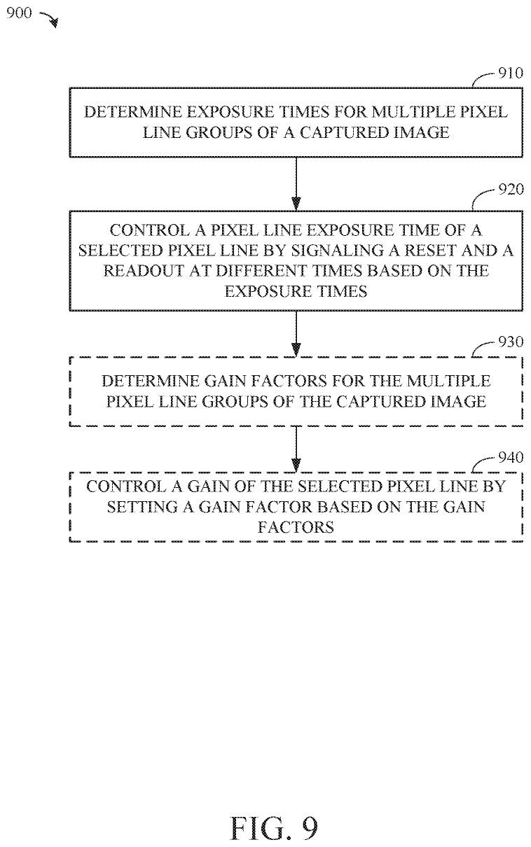

FIG. 9 is a flowchart of an example technique 900 for performing variable exposure time processing and gain processing. The technique 900 includes: determining 910 exposure times for multiple pixel line groups of a captured image; and controlling 920 a pixel line exposure time of a selected pixel line by signaling a reset and a readout at different times based on the exposure times. In an implementation, the technique 900 further includes determining 930 gain factors for the multiple pixel line groups of the captured image; and controlling 940 a gain of the selected pixel line by setting a gain factor based on the gain factors. For example, the technique 900 may be implemented by the image capture device 100 shown in FIGS. 1A-1D, the image capture device 200 shown in FIGS. 2A-2D, the image capture device 310 shown in FIGS. 3A-3B, or the image capture device 400 of FIGS. 4A-4B. The order is illustrative and may occur in other orders or in combined steps.

The technique 900 includes determining 910 exposure times for multiple pixel line groups of a captured image. An image is captured by an image sensor of an image capture device. An auto-exposure module or processor of the image capture device groups pixel lines of the captured image based on an image characteristic or feature. For example, the pixel lines can be grouped based on brightness, sky identification, defined number of pixel lines, darkness, ground identification, and the like. The auto-exposure module or processor of the image capture device then determines an exposure time for pixel line group using conventional or standard techniques.

The technique 900 includes controlling 920 a pixel line exposure time of a selected pixel line by signaling reset and readout at different times based on the exposure times. The auto-exposure module or processor programs or controls the reset and read times of the image sensor using the exposure times. By setting different times for the reset and read times, the exposure time can be varied on a per pixel line basis. In an implementation, conventional or standard gain processing may be applied to each pixel line that is readout.

In some implementations, the technique 900 includes determining 930 gain factors for the multiple pixel line groups of the captured image. The auto-exposure module or processor determines gain factors for the multiple pixel line groups using conventional or standard techniques.

The technique 900 includes controlling 940 a gain of the selected pixel line by setting a gain factor based on the gain factors. The auto-exposure module or processor programs or controls the gain element of the image sensor using the gain factors. The gain factor can be varied on a per pixel line basis.

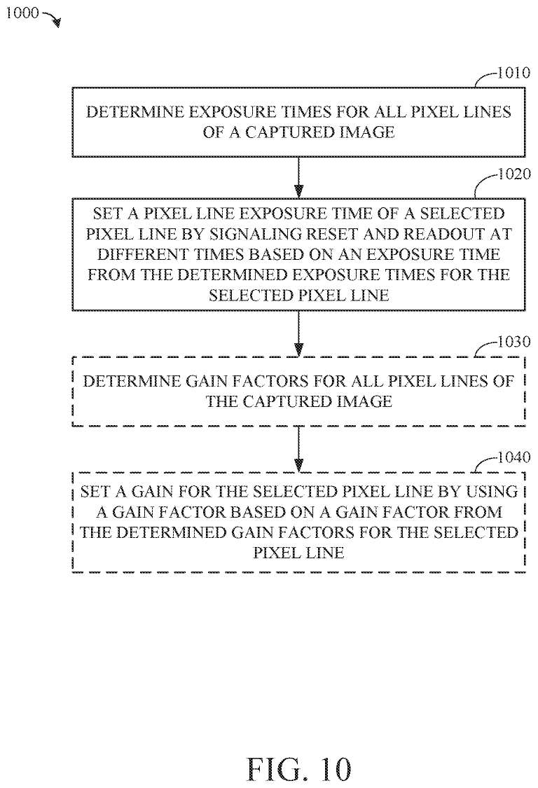

FIG. 10 is a flowchart of an example technique 1000 for performing variable exposure time processing and gain processing. The technique 1000 includes: determining 1010 exposure times for all pixel lines of a captured image; and setting 1020 a pixel line exposure time of a selected pixel line by signaling reset and readout at different times based on an exposure time from the determined exposure times for the selected pixel line. In an implementation, the technique 1000 further includes determining 1030 gain factors for all pixel lines of the captured image; and setting 1040 a gain for the selected pixel line by using a gain factor based on a gain factor from the determined gain factors for the selected pixel line. For example, the technique 1000 may be implemented by the image capture device 100 shown in FIGS. 1A-1D, the image capture device 200 shown in FIGS. 2A-2D, the image capture device 310 shown in FIGS. 3A-3B, or the image capture device 400 of FIGS. 4A-4B. The order is illustrative and may occur in other orders or in combined steps.

The technique 1000 includes determining 1010 exposure times for all pixel lines of a captured image. An image is captured by an image sensor of an image capture device. An auto-exposure module or processor of the image capture device determines an exposure time for each pixel line using conventional or standard techniques.

The technique 1000 includes setting 1020 a pixel line exposure time of a selected pixel line by signaling reset and readout at different times based on an exposure time from the determined exposure times for the selected pixel line. The auto-exposure module or processor programs or controls the reset and read times of the image sensor using the exposure times. By setting different times for the reset and read times, the exposure time can be varied on a per pixel line basis. In an implementation, conventional or standard gain processing may be applied to each pixel line that is readout.

In some implementations, the technique 1000 includes determining 1030 gain factors for all pixel lines of the captured image. The auto-exposure module or processor determines gain factors for each pixel line using conventional or standard techniques.

The technique 1000 includes setting 1040 a gain for the selected pixel line by using a gain factor based on a gain factor from the determined gain factors for the selected pixel line. The auto-exposure module or processor programs or controls the gain element of the image sensor using the gain factors. The gain factor can be varied on a per pixel line basis.

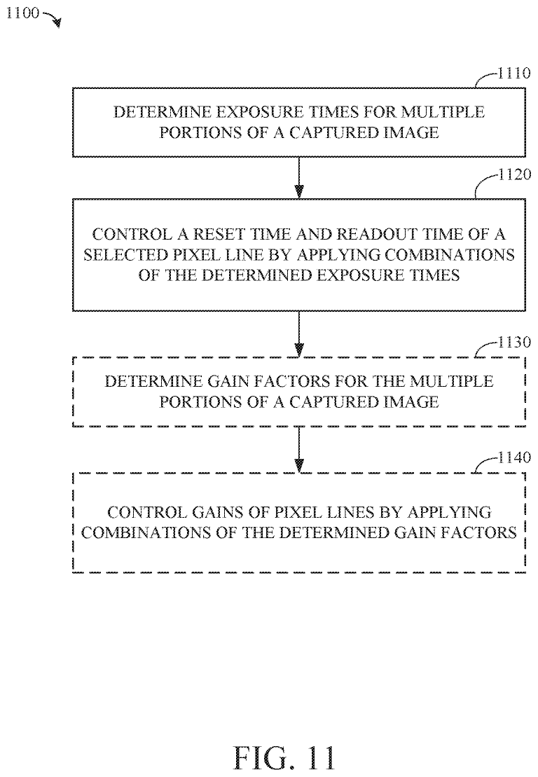

FIG. 11 is a flowchart of an example technique 1100 for performing variable exposure time processing and gain processing. The technique 1100 includes: determining 1110 exposure times for multiple portions of a captured image; and controlling 1120 a reset time and readout time of a selected pixel line by applying combinations of the determined exposure times. In an implementation, the technique 1100 further includes determining 1130 gain factors for the multiple portions of a captured image; and controlling 1140 gains of pixel lines by applying combinations of the determined gain factors. For example, the technique 1100 may be implemented by the image capture device 100 shown in FIGS. 1A-1D, the image capture device 200 shown in FIGS. 2A-2D, the image capture device 310 shown in FIGS. 3A-3B, or the image capture device 400 of FIGS. 4A-4B. The order is illustrative and may occur in other orders or in combined steps.

The technique 1100 includes determining 1110 exposure times for multiple portions of a captured image. An image is captured by an image sensor of an image capture device. An auto-exposure module or processor of the image capture device divides the captured image based on an image characteristic, image feature, top portion, bottom portion, bright portion, dark portion, sky feature, ground feature, defined number of pixel lines, groups of pixel lines, and the like. The auto-exposure module or processor of the image capture device then determines exposure times for all portions using conventional or standard techniques.

The technique 1100 includes controlling 1120 a reset time and readout time of a selected pixel line by applying combinations of the determined exposure times. The auto-exposure module or processor programs or controls the reset and read times of the image sensor using combinations of the exposure times. By setting different times for the reset and read times, the exposure time can be varied on a per pixel line basis. In an implementation, conventional or standard gain processing may be applied to each pixel line that is readout.

In some implementations, the technique 1100 includes determining 1130 gain factors for the multiple portions of a captured image. The auto-exposure module or processor determines gain factors for each portion using conventional or standard techniques.

The technique 1100 includes controlling 1140 gains of pixel lines by applying combinations of the determined gain factors. The auto-exposure module or processor programs or controls the gain element of the image sensor using combination of the gain factors. The gain factor can be varied on a per pixel line basis.

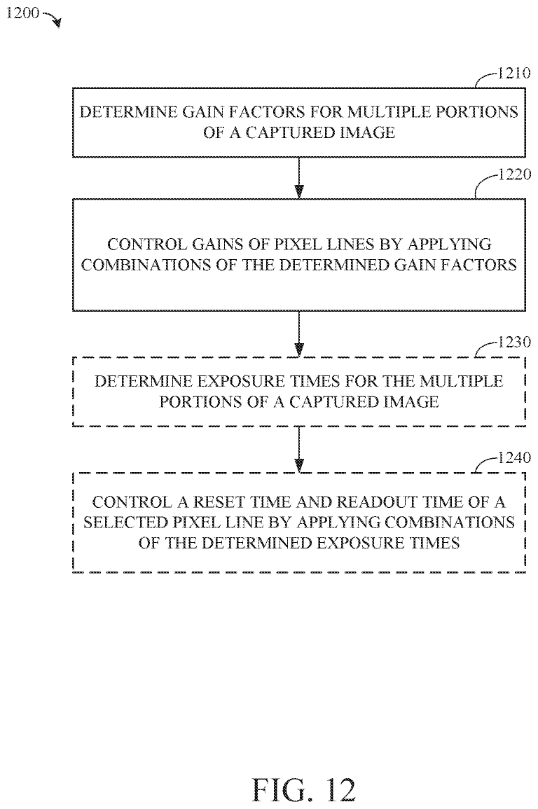

FIG. 12 is a flowchart of an example technique 1200 for performing variable gain processing and exposure time processing. The technique 1200 includes: determining 1210 gain factors for multiple portions of a captured image; and controlling 1220 gains of pixel lines by applying combinations of the determined gain factors. In an implementation, the technique 1200 further includes determining 1230 exposure times for multiple portions of a captured image; and controlling 1240 a reset time and readout time of a selected pixel line by applying combinations of the determined exposure times. For example, the technique 1200 may be implemented by the image capture device 100 shown in FIGS. 1A-1D, the image capture device 200 shown in FIGS. 2A-2D, the image capture device 310 shown in FIGS. 3A-3B, or the image capture device 400 of FIGS. 4A-4B. The order is illustrative and may occur in other orders or in combined steps.

The technique 1200 includes determining 1210 gain factors for multiple portions of a captured image. An image is captured by an image sensor of an image capture device. An auto-exposure module or processor of the image capture device divides the captured image based on an image characteristic, image feature, top portion, bottom portion, bright portion, dark portion, sky feature, ground feature, defined number of pixel lines, groups of pixel lines, and the like. The auto-exposure module or processor of the image capture device then determines gain factors for all portions using conventional or standard techniques. In an implementation, conventional or standard exposure time processing may be applied to each pixel line that is being readout.

The technique 1200 includes controlling 1220 gains of pixel lines by applying combinations of the determined gain factors. The auto-exposure module or processor programs or controls the gain element of the image sensor using combinations of the gain factors. The gain factor can be varied on a per pixel line basis.

In some implementations, the technique 1200 includes determining 1230 exposure times for the multiple portions of a captured image. The auto-exposure module or processor of the image capture device determines exposure times for all portions using conventional or standard techniques.

The technique 1200 includes controlling 1240 a reset time and readout time of a selected pixel line by applying combinations of the determined exposure times. The auto-exposure module or processor programs or controls the reset and read times of the image sensor using combinations of the exposure times. By setting different times for the reset and read times, the exposure time can be varied on a per pixel line basis.

Where certain elements of these implementations may be partially or fully implemented using known components, those portions of such known components that are necessary for an understanding of the present disclosure have been described, and detailed descriptions of other portions of such known components have been omitted so as not to obscure the disclosure.

In the present specification, an implementation showing a singular component should not be considered limiting; rather, the disclosure is intended to encompass other implementations including a plurality of the same component, and vice-versa, unless explicitly stated otherwise herein. Further, the present disclosure encompasses present and future known equivalents to the components referred to herein by way of illustration.

As used herein, the term “bus” is meant generally to denote any type of interconnection or communication architecture that may be used to communicate data between two or more entities. The “bus” could be optical, wireless, infrared, or another type of communication medium. The exact topology of the bus could be, for example, standard “bus,” hierarchical bus, network-on-chip, address-event-representation (AER) connection, or other type of communication topology used for accessing, for example, different memories in a system.

As used herein, the terms “computer,” “computing device,” and “computerized device” include, but are not limited to, personal computers (PCs) and minicomputers (whether desktop, laptop, or otherwise), mainframe computers, workstations, servers, personal digital assistants (PDAs), handheld computers, embedded computers, programmable logic devices, personal communicators, tablet computers, portable navigation aids, Java 2 Platform, Micro Edition (J2ME) equipped devices, cellular telephones, smartphones, personal integrated communication or entertainment devices, or another device capable of executing a set of instructions.

As used herein, the term “computer program” or “software” is meant to include any sequence of machine-cognizable steps which perform a function. Such program may be rendered in any programming language or environment including, for example, C/C++, C#, Fortran, COBOL, MATLAB™, PASCAL, Python, assembly language, markup languages (e.g., HTML, Standard Generalized Markup Language (SGML), XML, Voice Markup Language (VoxML)), as well as object-oriented environments such as the Common Object Request Broker Architecture (CORBA), Java™ (including J2ME, Java Beans), and/or Binary Runtime Environment (e.g., Binary Runtime Environment for Wireless (BREW)).

As used herein, the terms “connection,” “link,” “transmission channel,” “delay line,” and “wireless” mean a causal link between two or more entities (whether physical or logical/virtual) which enables information exchange between the entities.

As used herein, the terms “integrated circuit,” “chip,” and “IC” are meant to refer to an electronic circuit manufactured by the patterned diffusion of trace elements into the surface of a thin substrate of semiconductor material. By way of non-limiting example, integrated circuits may include FPGAs, PLDs, RCFs, SoCs, ASICs, and/or other types of integrated circuits.

As used herein, the term “memory” includes any type of integrated circuit or other storage device adapted for storing digital data, including, without limitation, read-only memory (ROM), programmable ROM (PROM), electrically erasable PROM (EEPROM), DRAM, Mobile DRAM, synchronous DRAM (SDRAM), Double Data Rate 2 (DDR/2) SDRAM, extended data out (EDO)/fast page mode (FPM), reduced latency DRAM (RLDRAM), static RAM (SRAM), “flash” memory (e.g., NAND/NOR), memristor memory, and pseudo SRAM (PSRAM).

As used herein, the term “Wi-Fi” includes one or more of IEEE-Std. 802.11, variants of IEEE-Std. 802.11, standards related to IEEE-Std. 802.11 (e.g., 802.11a/b/g/n/s/v), and/or other wireless standards.

As used herein, the term “wireless” means any wireless signal, data, communication, and/or other wireless interface. By way of non-limiting example, a wireless interface may include one or more of Wi-Fi, Bluetooth, 3G (3GPP/3GPP2), High Speed Downlink Packet Access/High Speed Uplink Packet Access (HSDPA/HSUPA), Time Division Multiple Access (TDMA), Code Division Multiple Access (CDMA) (e.g., IS-95A, Wideband CDMA (WCDMA), and/or other wireless technology), Frequency Hopping Spread Spectrum (FHSS), Direct Sequence Spread Spectrum (DSSS), Global System for Mobile communications (GSM), PAN/802.15, WiMAX (802.16), 802.20, narrowband/Frequency Division Multiple Access (FDMA), Orthogonal Frequency Division Multiplex (OFDM), Personal Communication Service (PCS)/Digital Cellular System (DCS), LTE/LTE-Advanced (LTE-A)/Time Division LTE (TD-LTE), analog cellular, Cellular Digital Packet Data (CDPD), satellite systems, millimeter wave or microwave systems, acoustic, infrared (i.e., IrDA), and/or other wireless interfaces.

As used herein, the terms “camera,” or variations thereof, and “image capture device,” or variations thereof, may be used to refer to any imaging device or sensor configured to capture, record, and/or convey still and/or video imagery which may be sensitive to visible parts of the electromagnetic spectrum, invisible parts of the electromagnetic spectrum (e.g., infrared, ultraviolet), and/or other energy (e.g., pressure waves).

While certain aspects of the technology are described in terms of a specific sequence of steps of a method, these descriptions are illustrative of the broader methods of the disclosure and may be modified by the particular application. Certain steps may be rendered unnecessary or optional under certain circumstances. Additionally, certain steps or functionality may be added to the disclosed implementations, or the order of performance of two or more steps may be permuted. All such variations are considered to be encompassed within the disclosure.

While the above-detailed description has shown, described, and pointed out novel features of the disclosure as applied to various implementations, it will be understood that various omissions, substitutions, and changes in the form and details of the devices or processes illustrated may be made by those skilled in the art without departing from the disclosure. The foregoing description is in no way meant to be limiting, but rather should be taken as illustrative of the general principles of the technology.

1. An image capture device comprising:
an image sensor configured to capture image information, the image sensor including:
an array of pixels;
a reset circuit configured to reset a line of pixels in the array of pixels; and
a readout circuit configured to obtain readout signals from the line of pixels; and
a processor configured to:
determine a first exposure time for a first portion of the image information;
determine a second exposure time for a second portion of the image information; and
variably control a pixel line exposure time for a selected line of pixels by signaling the reset circuit at a reset time and the readout circuit at a readout time,
wherein the reset time and the readout time are signaled at different times and are based on the first exposure time and the second exposure time, and
wherein the first exposure time, the second exposure time, and the pixel line exposure time are elapsed times between the reset time and the readout time.

2. The image capture device of claim 1, the image sensor further comprising:
a gain element configured to amplify the readout signals, wherein the processor is further configured to:
determine a first gain factor for a first portion of the image information;
determine a second gain factor for a second portion of the image information; and
variably control the gain element for the selected line of pixels based on the first gain factor and the second gain factor.

3. The image capture device of claim 1, wherein the processor is further configured to:
apply a first gain factor to a first line of pixels;
apply a second gain factor to a last line of pixels; and
determine gain factors for lines of pixels between the first line of pixels and the last line of pixels based on combinations of the first gain factor and the second gain factor.

4. The image capture device of claim 1, wherein the processor is further configured to:
interpolate gain factors for lines of pixels between a first line of pixels and a last line of pixels based on a first gain factor and a second gain factor.

5. The image capture device of claim 1, wherein the processor is further configured to:
apply the first exposure time to a first line of pixels; and
apply the second exposure time to a last line of pixels.

6. The image capture device of claim 1, wherein the processor is further configured to:
determine pixel line exposure times for lines of pixels between a first line of pixels and a last line of pixels based on combinations of the first exposure time and the second exposure time.

7. The image capture device of claim 1, wherein the processor is further configured to:
interpolate pixel line exposure times for lines of pixels between a first line of pixels and a last line of pixels based on the first exposure time and the second exposure time.

8. The image capture device of claim 7, wherein interpolation is a linear function between the first line of pixels and the last line of pixels.

9. An image capture system comprising:
an image sensor configured to capture image information, the image sensor including a plurality of pixel lines;
a gain element configured to amplify readout signals from a selected pixel line; and
a processor configured to:
determine a gain factor for a portion of the image information, wherein the image information includes two or more portions; and
variably control the gain element for a selected pixel line based on the gain factor.

10. The image capture system of claim 9, wherein the processor is further configured to:
determine a gain factor for the selected pixel line based on combinations of gain factors for the two or more portions.

11. The image capture system of claim 9, wherein the plurality of pixel lines is addressed by reset lines and readout lines, and the processor is further configured to:
determine portion exposure times for the two or more portions of the image information; and
variably control a pixel line exposure time for the selected pixel line by signaling an appropriate reset line and an appropriate readout line at different times which are based on the portion exposure times,
wherein the portion exposure times and the pixel line exposure time are elapsed times between a reset time and a readout time.

12. The image capture system of claim 11, wherein the processor is further configured to:
determine the pixel line exposure time for the selected pixel line based on combinations of the portion exposure times.

13. The image capture system of claim 9, wherein the two or more portions is at least one of:
a top portion of the image information and a bottom portion of the image information;
multiple groups of pixel lines; and
all pixel lines in the image sensor.

14. A method for variable exposure time and gain processing, the method comprising:
determining a portion exposure time for a portion of image information, wherein the image information includes two or more portions; and
variably controlling a pixel line exposure time for a selected pixel line of an image sensor by signaling a reset circuit at a reset time and a readout circuit at a readout time,
wherein the reset time and the readout time are signaled at different times and are based on two or more portion exposure times, and
wherein the portion exposure time, the two or more portion exposure times, and the pixel line exposure time are elapsed times between the reset time and the readout time.

15. The method of claim 14, further comprising:
determining gain factors for the two or more portions; and
variably controlling a gain element for the selected pixel line based on the gain factors.

16. The method of claim 14, further comprising:
determining a first gain factor for one portion of the two or more portions;
determine a second gain factor for another portion of the two or more portions; and
variably controlling a gain element for the selected pixel line based on the first gain factor and the second gain factor.

17. The method of claim 14, further comprising:
applying a first gain factor to a first line of pixels of the image information;
applying a second gain factor to a last line of pixels of the image information; and
determining gain factors for lines of pixels between the first line of pixels and the last line of pixels based on combinations of the first gain factor and the second gain factor.

18. The method of claim 14, further comprising:
interpolating gain factors for lines of pixels of the image information between a first line of pixels and a last line of pixels based on a first gain factor and a second gain factor.

19. The method of claim 17, further comprising:
applying a first exposure time to the first line of pixels; and
applying a second exposure time to the last line of pixels.

20. The method of claim 19, further comprising:
determining pixel line exposure times for lines of pixels between the first line of pixels and the last line of pixels based on combinations of the first exposure time and the second exposure time.
